SEQUENCE LISTING (4 sequences)

SEQ ID NO: 1 - protein, 9 aa, Bos taurus
GDSVAYGLK

SEQ ID NO: 2 - protein, 16 aa, Bos taurus
YPDAVATWLKPDPSQK

SEQ ID NO: 3 - protein, 4 aa, Bos taurus
YPDA

SEQ ID NO: 4 - protein, 4 aa, Bos taurus
GDSV

(19) United States
(12) Patent Application Publication
(10) Pub. No.: US 2025/0280846 A1
(43) Pub. Date: Sep. 11, 2025

(54) USE OF MILK PROTEIN FRACTIONS AS A SOURCE OF OSTEOPONTIN

(71) Applicant: SOCIETE DES PRODUITS NESTLE S.A., Vevey (CH)

(72) Inventors: BRITTANY BERRY, Bern (CH); PETER ERDMANN, Bern (CH); JONATHAN O'REGAN, Killarney (IE)

(21) Appl. No.: 18/556,001

(22) PCT Filed: Apr. 14, 2022
(86) PCT No.: PCT/EP2022/060004

§ 371 Date: Oct. 18, 2023

(30) Foreign Application Priority Data
Apr. 19, 2021 (EP) 21169121.7

(51) Int. Cl. A23C 9/142; A23L 33/00; A23L 33/19

(52) U.S. Cl. CPC A23C 9/1422; A23L 33/19; A23L 33/40; A23C 2210/206

(57) ABSTRACT

The present invention relates to the use of specific milk protein fractions as a source of osteopontin, and to the use of said milk protein fractions to optimise the osteopontin concentration in a synthetic nutritional composition for an infant or child. The invention further relates to the use of said synthetic nutritional composition for an infant or child to support and/or optimise growth and development, immune response, galactose metabolism and cytoskeleton remodeling. The invention also relates to a low-protein synthetic nutritional composition for an infant or child comprising the milk protein fractions.

### CROSS REFERENCE TO RELATED APPLICATIONS

The present application is a National Stage of International Application No. PCT/EP2022/060004, filed on Apr. 14, 2022, which claims priority to European Patent Application No. 21169121.7, filed on Apr. 19, 2021, the entire contents of which are being incorporated herein by reference.

### SEQUENCE LISTING

The instant application contains a Sequence Listing which has been submitted electronically in ASCII text file format and is hereby incorporated by reference in its entirety. Said ASCII text file copy, created on May 15, 2024, is named 3712036-04659_SL.txt and is 798 bytes in size.

### FIELD OF THE INVENTION

The present invention relates to the use of specific milk protein fractions as a source of osteopontin, the enrichment of osteopontin in said fraction and to the use of said enriched milk protein fractions to optimise the osteopontin concentration in a synthetic nutritional composition for an infant or child. The invention further relates to the use of said synthetic nutritional composition for an infant or child to support and/or optimise growth and development, immune response, galactose metabolism and cytoskeleton remodeling. The invention also relates to a low-protein synthetic nutritional composition for an infant or child comprising the milk protein fractions.

### BACKGROUND TO THE INVENTION

Breast-feeding is recommended for all infants. However, in some cases breast-feeding is insufficient or not possible for medical reasons. In these situations infant formula can be used as a substitute for breast milk. However, studies have shown that the composition of infant formula is not identical to that of breast-milk, and that it may not always have identical effects on the body. In light of this, and in light of the fact that breast-milk is considered the gold standard when it comes to infant nutrition, a goal of infant formula manufacturers is to further develop the compositions of their infant formulas and growing-up milks and to bring them closer to breast milk.

Mammalian milk, in particular cow milk, is typically used as basis for synthetic infant formula and growing-up milks. Such milks however differ from human milk for example in the content of specific proteins having a beneficial effect on the infant or child. Examples of such proteins include for example osteopontin, Nactalbumin, lactoferrin, among others.

Osteopontin in breast-milk is present in an amount far exceeding that in infant formula. This can result in formula-fed infants having a lower osteopontin intake which may have negative effects on their growth and development, immune response, galactose metabolism and cytoskeleton remodeling. In an effort to address this gap, infant formula manufacturers have aimed to increase the concentration of osteopontin in their infant formulas. However, this can pose a challenge. Dairy sources used in infant formula to provide osteopontin, e.g. whey protein or extracts thereof, often only comprise osteopontin in low concentrations, and this makes it impossible to use them in infant formula in the concentrations required to supply a sufficient amount of osteopontin without providing an excess of another ingredient, such as protein, and/or without having to reduce the quantities of other important nutrients in the infant formula composition. Whilst sources of pure or essentially pure osteopontin are available, these are often unsuitable for use in infant formula.

Accordingly, there is a need to identify ingredients that can be used in infant formulas as a source of osteopontin that do not suffer from one or more of the drawbacks listed above.

Surprisingly, the inventors have now found that a milk protein fractions obtained by use of a particular process detailed herein (hereinafter the “milk protein fractions”), comprises osteopontin in a concentration far higher than that found in milk protein compositions. This advantageously enables these particular milk fractions to be used as a source of osteopontin and to optimise the concentration of osteopontin in a composition for an infant or child. As osteopontin is typically provided in the form of ingredients comprising significant amounts of additional milk protein, such as whey, the protein content in the infant formula in which a separate ingredient has been added would have a significantly higher protein content compared to a formula in which the present milk fractions are used. In contrast, the present milk protein fractions comprise very low amounts of proteins in addition to osteopontin. Thus, these are particularly useful in infant formula and even more in infant formula intended to have a low protein content.

### SUMMARY OF THE INVENTION

The present invention encompasses the use of a milk protein fraction as a source of osteopontin (OPN) in a synthetic nutritional composition for an infant or child wherein, the milk protein fraction is obtained by a process comprising:
i) providing a liquid lactic raw material
ii) decationization of the liquid lactic raw material, such that the pH has a value of 1 to 4.5,
iii) bringing the said liquid into contact with a weak anionic resin of hydrophobic matrix, predominantly in alkaline form up to a stabilized pH,
iv) separation of the resin and the liquid product which is recovered, and
v) desorption of cGMP from the resin,
vi) performing at least one ultrafiltration step, and
vii) collecting the permeate and/or retentate fraction rich in OPN.

In one embodiment of the present invention, the milk fraction rich in OPN is collected in the permeate.

In one embodiment of the present invention, the steps v-vi described above is performed under pH ranging from 4 to 8. In one embodiment of the present invention, the ion balance is further modified by calcium or phosphate addition.

In one embodiment of the present invention, the ultrafiltration step is performed using membrane size between preferably 30 to 100 KDa.

In another aspect, the present invention relates to a synthetic nutritional composition for an infant or child comprising a milk protein as defined in above process comprising steps (i) to (vii). The synthetic nutritional composition for an infant or child may be a composition for consumption by infants either alone or in combination with human breast milk, and may be an infant formula, a follow-up or follow-on formula, a growing-up milk, a supplement or a human breast milk fortifier.

The milk protein fraction obtained as described herein, or a synthetic nutritional composition comprising it, may be used to provide an infant or child with an optimized amount of osteopontin, it may also be used to support and/or optimise the growth and/or development of an infant or child, to support and/or optimise the immune response of an infant or child, in the treatment and/or prevention of sub-optimal immune response of an infant or child, in the treatment and/or prevention of sub-optimal growth of an infant or child.

It is particularly useful to have osteopontin provided as part of a milk protein fraction as described herein, because such an ingredient is cost-effective, safe and advantageous way of providing osteopontin. In particular, the present milk protein fraction have an ash content that is typically lower than currently available purified osteopontin ingredient. The present milk protein fraction also contain low amounts of proteins other than osteopontin, which makes it more suitable than other commercial milk protein fractions.

The invention will now be described in further detail.

### BRIEF DESCRIPTION OF FIGURES

FIG. 1: dry matter content demonstrated as in 100% from original fraction

FIG. 2: protein content demonstrated as in 100% from original fraction

FIG. 3: ash content demonstrated as in 100% from original fraction

FIG. 4: ultrafiltration of OPN

FIG. 5: OPN content demonstrated as in 100% from original fraction

FIG. 6: cGMP samples before and after filtration (30 kDa); highest OPN retention

FIG. 7: cGMP samples before and after filtration (50 kDa)

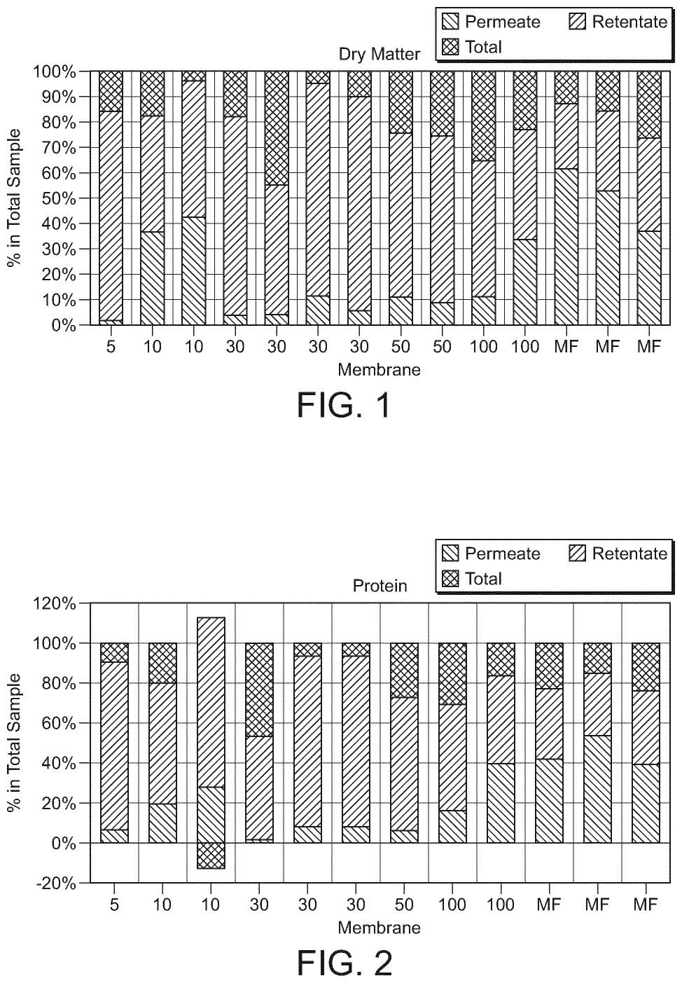

### DETAILED DESCRIPTION

As lactic raw material, there may be used in the process according to the invention any product or by-product containing GMP. There may be mentioned as a guide:
sweet whey obtained after separation of casein coagulated with rennet,
a sweet whey or such a whey demineralized to a greater or lesser degree, for example by electrodialysis, ion exchange, reverse osmosis, electrodeionization or a combination of these procedures,
a concentrate of sweet whey,
a concentrate of sweet whey demineralized to a greater or lesser degree, for example by electrodialysis, ion exchange, reverse osmosis, electrodeionization or a combination of these procedures,
a concentrate of proteins of substantially lactose-free sweet whey obtained, for example, by ultrafiltration, followed by diafiltration (ultrafiltration with washing),
mother liquors of the crystallization of lactose from a sweet whey,
a permeate of ultrafiltration of a sweet whey,
the product of hydrolysis, by a protease, of a native casein obtained by acid precipitation of skimmed milk with an inorganic acid or by biological acidification, where appropriate with addition of calcium ions or alternatively of a micellar casein, obtained for example by microfiltration of a skimmed milk,
the product of hydrolysis of a caseinate by a protease.

A preferred raw material is a preconcentrated sweet whey from cheesemaking, preferably at 10-23% by weight and decationized or completely deionized, that is to say freed of cation and freed of anion.

Another preferred material is a protein concentrate of lactose-free and cation-free sweet whey. These raw materials may be provided in liquid form or in powdered form, and in the latter case, they are dispersed in water, preferably demineralized with a view to their subsequent treatment.

These raw materials can be derived from the milk of ruminants, such as cows, goats, sheep, camel, donkeys or buffaloes. A “milk protein fraction” is herein defined as a milk protein fraction that has been obtained by the above-described process or by any preferred embodiment of the process described herein or in U.S. Pat. No. 6,787,158.

The milk protein fraction obtained by the specific process described herein has been found to be surprisingly rich in osteopontin and can advantageously be used to optimise the osteopontin concentration is a synthetic nutritional composition for an infant or child. The milk protein fraction may be added to a synthetic nutritional composition in an effective amount, enough to ensure that the said composition has a final concentration of osteopontin in a range found in human breast milk.

In a preferred aspect the liquid lactic raw material and the milk protein fraction both contain caseino glyco-macropeptide (cGMP). cGMP is a phosphorylated and partially sialylated macropeptide which is formed by the action of a protease, for example rennet, on mammalian milk kappa-casein. It represents about 20% by weight of the proteins in the sweet whey obtained after separation of casein during cheese manufacture. In a most preferred aspect, the milk protein fraction is enriched in cGMP. A “milk protein fraction enriched in cGMP” is herein defined as a milk protein fraction that has been processed to increase the amount of cGMP in the milk protein fraction compared to the un-processed lactic raw material. Embodiments wherein the milk protein fraction is also a rich source of cGMP are advantageous.

According to a first embodiment of the process, the liquid raw material is brought into contact with a weakly anionic resin in a reactor, with gentle stirring, at a temperature<50° C., preferably between 0 and 15° C. The stirring should be just sufficient for fluidization of the resin bed. It can be produced, for example, by a stirrer or, preferably, by the introduction of a stream of fluid, for example of air or nitrogen under pressure through the bottom of the reactor.

It is possible to use any anion-exchange resin whose matrix is hydrophobic and in which the exchanging groups are weakly basic in macroporous or macrocross-linked, preferably polystyrene or polyacrylic, gel form, particularly based on polystyrene/divinylbenzene copolymer and preferably macrocross-linked because of considerations of resistance to osmotic shocks. The active groups are generally primary to tertiary amines. Such a resin should predominantly be in alkaline form (termed hereinafter OH— form) and therefore its active sites should preferably have been largely regenerated in this form.

During this bringing into contact, the active sites of the resin are exchanged against the GMP molecules, producing a gradual increase in the pH of the treated liquid, up to a stabilized final value, for example of 4.5 to 5.5 depending on the raw material used. The duration of the operation and the respective quantities of resin and of treated liquid are chosen as a function of the composition of the starting material and the desired quantity of GMP. This operation lasts from 1 to 10 h, for example for about 4 h. The respective proportions of resin and of liquid to be treated can vary widely and are, by volume, from 1:1 to 1:30 and preferably from 1:1 to 1:10, depending on the desired degree of separation of the GMP.

According to another embodiment, the liquid can be percolated through a column filled with the resin, the treated liquid collected therefrom and the GMP adsorbed onto the resin recovered by elution. To do this, the procedure can be carried out continuously or semicontinuously, for example by extracting the saturated resin from the column countercurrentwise and by replacing it with freshly regenerated resin.

The preceding embodiments, in a reactor and in a column, can be combined, for example, using a mixed device whose upper part is a reactor provided with means for stirring or for production of a fluidized bed containing the resin, separated by a grid or a filter from a lower part consisting of a column where, at the end of the treatment, the resin can be recovered, for example by decantation, and the treated liquid drawn off.

The liquid thus treated can be concentrated, for example by evaporation, and then dried, for example by spray-drying in a drying tower. Such liquid or powder advantageously serves as protein raw material in the preparation of infant products and is remarkable because of its desired amino acid profile, its aminogram showing a reduction in threonine and an enrichment in aromatic amino acids such as tryptophan.

To separate the milk fraction containing cGMP therefrom, the resin is first treated by washing, for example with demineralized water, and then, where appropriate, with a dilute saline solution or a dilute acidic solution and it is rinsed with demineralized water. The actual desorption of the GMP is carried out with an aqueous solution of acid, base or salt, preferably with a basic aqueous solution, for example NaOH, KOH or Ca(OH)2, advantageously of concentration<8% by weight, preferably of 0.5 to 3%, followed by washing with demineralized water. In this manner, the resin is regenerated at the same time. The eluate and the washings are then combined and they are then ultrafiltrated with a mean cut-off size of 5 to 100 kDa. Preferably the range is used between 30 and 100 kDa.

In an embodiment of the present invention the milk protein fraction is rich in osteopontin and comprises at least 100 mg, preferably at least 150 mg, more preferably at least 200 mg, even more preferably at least 220 mg and most preferably 240 mg of osteopontin per 100 g. In a preferred aspect of the invention, the amount of osteopontin is determined in accordance with the method described in Example 1 below.

In an embodiment of the present invention the milk protein fraction more than doubles in its osteopontin content through the filtration process (as shown in Example 3). In a preferred aspect of the invention, the amount of osteopontin is determined in accordance with the method described in Example 1 below.

The term “osteopontin” as used herein preferably refers to bovine or human osteopontin, such as characterized in Christensen et al.; Structure, function and nutritional potential of milk osteopontin; International Dairy Journal 57 (2016): 1-6. Posttranslational modifications of bovine osteopontin: Identification of twenty-eight phosphorylation and three 0-glycosylations sites.

The milk protein fraction is particularly suitable for use as a source of osteopontin in a synthetic nutritional composition for an infant or child e.g. an infant formula or composition for consumption by an infant or child either alone or in combination with human breast milk. As previously stated herein, it is known that the osteopontin concentration can differ between breast milk and infant formula; given the positive wellness effects associated with an adequate osteopontin intake, there is a need to optimise the osteopontin concentration in said compositions. In another aspect of the present invention there is provided the use of a milk protein fraction such as described herein to optimise the osteopontin concentration of a synthetic nutritional composition for an infant or child wherein said milk protein fraction is obtained by a process as detailed herein.

The milk protein fraction may be added to a synthetic nutritional composition in any amount effective (an effective amount) to optimise the concentration of osteopontin in said synthetic nutritional composition for an infant or child.

Given that human breast milk is the gold standard when it comes to infant and/or child nutrition, the concentration of osteopontin in a synthetic nutritional composition for an infant or child may be considered optimised if the concentration of osteopontin is within a range, or above a range, found in human breast milk.

Osteopontin has been found to be present in breast milk in a concentration range of about 10 to 500 mg/L, preferably 10 to 350 mg/L and in particular in a concentration range of 10 to 324 mg/L.

Accordingly, an effective amount of the milk protein fraction may be an amount sufficient to provide osteopontin in one or more of these ranges or in a higher concentration. An effective amount may also be an amount sufficient to ensure that the synthetic nutritional composition has a final concentration of osteopontin in one or more of these ranges or in a higher concentration when considering other ingredients comprised in the composition that comprise osteopontin e.g. dairy ingredients such as skimmed milk powder and whey protein. Said ingredients may comprise osteopontin innately.

It is well within the purview of the person skilled in the art to determine an effective amount of the milk protein fraction to be added to the synthetic nutritional composition for an infant or child, based upon the amount of osteopontin found in human breast milk and the concentration of osteopontin in the milk protein fraction, and when applicable the concentration of osteopontin coming from other ingredients comprised in the synthetic nutritional composition for an infant or child. The skilled person can in particular determine the innate amount of osteopontin in an ingredient used by applying the method described in Example 1.

The optimised concentration of osteopontin may be the concentration of osteopontin in the synthetic nutritional composition upon reconstitution for example with milk or water. It is well within the purview of the skilled person to determine an effective amount taking into consideration the concentration of osteopontin in the milk protein fraction and when appropriate reconstitution instructions for the synthetic nutritional composition.

A particular advantage of the milk protein fraction used in the invention is that it can provide an optimised amount of osteopontin to a synthetic nutritional composition for an infant or child and negate the need to add additional ingredients for this purpose, for example additional ingredients whose addition would be for the sole or primary purpose of increasing the osteopontin concentration e.g. isolated osteopontin. Accordingly, in an embodiment the milk protein fraction is not used in combination with an additional ingredient whose sole or primary purpose would be to increase the osteopontin concentration in the synthetic nutritional composition, for example it is not used in combination with isolated osteopontin.

The term “infant” as used herein refers to a human infant of up to 12 months of age and includes preterm and very preterm born infants, infants having a low birth weight i.e. a new born having a body weight below 2500 g (5.5 pounds) either because of preterm birth or restricted fetal growth, and infants born small for gestational age (SGA) i.e. babies with birth weights below the 10th percentile for babies of the same gestational age.

The term “child” as used herein refers to a human of 1 to 18 years of age, for example a human of 1 to 8 years of age, a human of 1 to 3 years of age, and/or a human of 1 to 2 years of age.

A “preterm” or “premature” means an infant or young child that was not born at term. Generally it refers to an infant born prior to the completion of 37 weeks of gestation.

The term “Ultrafiltration” describes the separation of particles in a range of 0.002-0.1 μm via a filtration process. Thereby, larger molecules are retained in the retentate, whilst smaller solvents and salts pass through the membrane (permeate). The separation of molecular masses takes place in a range between 300 and 300,000 daltons. Different molecular weights, as well as the pH and ionic strength determine the cut-off rate of the membrane. Furthermore, a variety of physico-chemical effects can cause binding of the macromolecules to the membrane. The separation is also driven by the applied pressure as described by the instructions manual for the membrane in use for this process. Thus, viscous resistances can be overcome, and the liquid permeates through the porous membrane network. An increase in the applied pressure most often leads to an increase of the flux rate. This however is limited by the concentration polarization, where a build-up of the solute concentration on the feed side leads to a boundary layer that causes additional membrane resistance and limits overall liquid permeation. Both fouling and the formation of a gel layer can lead to flux declines. They can be attributed to changes in the membranes chemical nature, such as crosslinking and compaction of the macromolecules (Scott, K. (1996). Overview of the application of synthetic membrane processes, Blackie Academic & Professional). The molecular weight cut off is normally rated by the molecular weight to which 90% of the solute is rejected. This number however varies between different suppliers. Furthermore, the analysis of this standardization is made under varying operating conditions of varying physico-chemical properties. Therefore, two membranes described as having the same molecular weight cut off, can have different pore sizes and performance characteristics when applied (Bennett, A. (2012). “Membrane technology; Developments in ultrafiltration technologies.” Filtration+Separation 49(6): 28-33).

Though by nature of the filtration process it can be expected that osteopontin, ranging at around 60 kDa should remain in the retentate when applying a smaller cut-off size (below 60 kDa), in the present embodiment of the invention, against the expectation, it could be shown that the greater fraction of OPN is found in the permeate (as seen in Example 3). The protein fraction, consisting mostly of cGMP (around 8 kDa), mainly remains in the retentate. It is thought that the monomeric cGMP fraction has agglomerated due to changes in its ion balance in the present invention and thus remains in the retentate.

All percentages disclosed herein with respect to the milk protein fraction are on a w/w basis unless stated otherwise.

The milk protein fraction may for example be used in an amount sufficient to provide 10 to 500, preferably 10 to 350, more preferably 10 to 324 mg of osteopontin per litre of nutritional composition.

In another aspect of the present invention there is provided a synthetic nutritional composition for an infant or child comprising a milk protein fraction obtained as disclosed herein.

In an embodiment the synthetic nutritional composition comprises the milk protein fraction in a concentration within a range of 4 to 30 g/L for example 4 to 25 g/L, preferably 4 to 20 g/L.

In an embodiment at least 10% of the total osteoponstin in the synthetic nutritional composition comes from the milk protein fraction, for example 10 to 100%, 49% to 100%, 49% to 70%.

A goal of infant formula manufacturers is to mimic the composition of human breast milk. However, the composition of human breast milk is extremely dynamic and changes over time. For this reason synthetic nutritional compositions for infants or children are usually stage based with a particular stage being suitable for use in infants or children falling within a particular age range e.g. stage 1 may be aimed at infants of 0 to 6 months, stage 2 may be aimed at infants of 6 months to 12 months, stage 3 may be aimed at children of 12 to 36 months, stage 4 may be aimed at children of 3 to 8 years. Each stage is formulated so that its composition is considered nutritionally sound with respect to the age range of the infant or child to whom it is directed.

In an embodiment of the present invention there is provided a synthetic nutritional composition for an infant or child comprising at least 16 g/L of the milk protein fraction used in the invention, preferably 16 to 25 g/L, more preferably 20 to 20 g/L. In an embodiment said composition is formulated for an infant of 0 to 6 months. In an embodiment the total concentration of osteopontin in said composition is at least 40 mg/L and more specifically in a range of 40 to 150 mg/L, even more specifically in a range of 50 to 131 mg/L.

In another embodiment of the present invention there is provided a synthetic nutritional composition for an infant or child comprising at least 8 g/L, preferably 8 to 30 g/L, more preferably 8 to 25 g/L, even more preferably 11 to 20 g/L of the milk protein fraction used in the invention. In an embodiment said composition is formulated for an infant of 6 to 12 months. In an embodiment the total concentration of osteopontin in said composition is at least 20 mg/L and more specifically in a range of 20 to 110 mg/L, even more specifically in a range of 28 to 103 mg/L.

In another embodiment of the present invention there is provided a synthetic nutritional composition for an infant or child comprising at least 10 g/L, preferably 10 to 30 g/L, more preferably 10 to 25 g/L, even more preferably 12 to 20 g/L of the milk protein fraction used in the invention. In an embodiment said composition is formulated for a child of 12 to 36 months. In an embodiment the total concentration of osteopontin in said composition is at least 25 mg/L and more specifically in a range of 25 to 110 mg/L, even more specifically in a range of 30 to 107 mg/L.

In another embodiment of the present invention there is provided a synthetic nutritional composition for an infant or child comprising at least 12 g/L, preferably 12 to 30 g/L, more preferably 14 to 25 g/L, even more preferably 16 to 20 g/L of the milk protein fraction used in the invention. In an embodiment said composition is formulated for a child of 3 to 8 years. In an embodiment the total concentration of osteopontin in said composition is at least 30 mg/L and more specifically in a range of 35 to 120 mg/L, even more specifically in a range of 39 to 111 mg/L.

In a preferred embodiment, the synthetic nutritional composition has a low total protein content. The amount of protein can be as low as adequate for the type of composition and the individual intended to consume it, such as for example according to nutritional requirements and/or regulations. For example the protein content is of at most 20 g/L, preferably at most 18 g/L, more preferably at most 16 g/L, even more preferably at most 15 g/L, even more preferable 14 g/L, even more preferably between 5 and 20 g/L, even more preferably 8 to 18 g/L, even more preferably 10 to 16 g/L, more preferably 11 to 15 g/L, more preferably 12 to 14 g/L, such as for example 13.5 g/L.

The synthetic nutritional composition for an infant or child can also comprise any other ingredients or excipients known to be employed in the type of synthetic nutritional composition in question e.g. infant formula.

Non limiting examples of such ingredients include: other proteins, amino acids, carbohydrates, oligosaccharides, lipids, prebiotics or probiotics, essential fatty acids, nucleotides, nucleosides, vitamins, minerals and other micronutrients.

Other suitable and desirable ingredients of synthetic nutritional compositions, that may be employed in the synthetic nutritional compositions for infants or children are described in guidelines issued by the Codex Alimentarius with respect to the type of synthetic nutritional composition in question e.g. Infant formula, growing up milk, HM fortifier, follow on formula, or food stuffs intended for consumption by infants e.g. complementary foods.

The milk protein fraction may be added to a synthetic nutritional composition for an infant or child by simply mixing it with other ingredients included in the composition.

Non limiting examples of synthetic nutritional compositions for an infant or child are infant formula, a growing up milk, a composition for infants that is intended to be added or diluted with human breast milk, or a food stuff intended for consumption by an infant and/or child either alone or in combination with human breast milk.

In an embodiment the synthetic nutritional composition is a low protein infant formula. A low protein infant formula will comprise less than 3.5 g of protein/100 kcal for example less than 2.5 g/100 kcal or less than 2 g/100 kcal. The low protein infant formula may be an infant formula formulated for an infant of up to 12 months of age, for example for an infant of 0 to 6 months of age, or an infant of 6 to 12 months of age.

The synthetic nutritional compositions for infants or children may be prepared by methods well known in the art for preparing the type of synthetic nutritional composition in question e.g. infant formulae, follow on formulae, a composition for infants that is intended to be added or diluted with human milk e.g. human milk fortifier, or food stuffs intended for consumption by infants either alone or in combination with human milk e.g. complementary foods.

An infant formula may for example be prepared by blending appropriate quantities of the milk protein fraction with skimmed milk, lactose, vegetable oils and fat soluble vitamins in water. These materials may be blended together in quantities sufficient to provide a final concentration of approximately 400 grams/liter. Mineral salts may then be added to the mixture prior to a high temperature/short time pasteurization step. Appropriate mineral salts include calcium chloride, calcium carbonate, sodium citrate, potassium hydroxide, potassium bicarbonate, magnesium chloride, ferrous sulfate, potassium citrate, zinc sulfate, calcium hydroxide, copper sulfate, magnesium sulfate, potassium iodide, sodium selenite, etc. The mixture may then be homogenized and cooled. Heat-labile vitamins and micronutrients may then be added to the mixture. The mixture may then be standardized with deionized water to a final total solids concentration of about 120 to about 135 for example about 123 grams per litre, which is equivalent to about 670 kcal per litre. The formula may then be sterilized using a conventional ultrahigh temperature or standard retort process. This sterilized material may then be placed in appropriate packaging.

In another aspect of the present invention there is provided the use of the milk protein fraction obtained as disclosed herein to provide an optimised amount of osteopontin to an infant or child. As disclosed herein, said milk protein fraction may be added to a synthetic nutritional composition in an amount effective to provide an optimised concentration of osteopontin.

Because human breast milk is the gold standard when it comes to infant nutrition, and because the synthetic nutritional compositions comprising the milk protein fraction disclosed herein may comprise osteopontin in an optimized concentration, they may be used to provide an optimum amount of osteopontin to an infant and thereby to ensure optimum osteopontin levels in an infant or child.

An optimum osteopontin intake has been associated with support and/or optimization of growth and development; immune response; galactose metabolism; and/or cytoskeleton remodeling in an infant or child.

Accordingly, in another aspect of the present invention there is provided a synthetic nutritional composition for an infant or child for use to treat or prevent sub-optimal growth and development, wherein said synthetic nutritional composition comprises a milk protein fraction obtained as disclosed herein in an amount effective to provide an optimised concentration of osteopontin. The composition may be a composition described herein.

The synthetic nutritional composition may be for use to prevent sub-optimal growth and development in an infant or child having impaired and/or delayed growth and/or development. It is within the purview of the skilled person to assess whether an infant or child is developing normally or whether the infant or child is suffering from impaired or delayed growth and/or development.

In yet another aspect there is provided the use of a synthetic nutritional composition comprising a milk protein extract obtained as disclosed herein in an amount effective to provide an optimized concentration of osteopontin to promote and/or optimise immune response in an infant or child to whom it is administered. The composition may be a composition described herein.

In yet another aspect there is provided the use of a synthetic nutritional composition comprising a milk protein fraction obtained as disclosed herein in an amount effective to provide an optimised concentration of osteopontin to promote and/or optimise galactose metabolism in an infant or child to whom it is administered. The composition may be a composition described herein.

In yet another aspect there is provided the use of a synthetic nutritional composition comprising a milk protein fraction obtained as disclosed herein in an amount effective to provide an optimised concentration of osteopontin to promote and/or optimise cytoskeleton remodeling in an infant or child to whom it is administered. The composition may be a composition described herein.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### Example 1

The amount of osteopontin contained in the ingredients listed in Table 1 was analyzed:

TABLE 1
Samples analysed for their osteopontin content

| Sample | Description | Invention Reference |
|---|---|---|
| Milk protein fraction | Milk protein fraction | Invention |
| used in the invention | used in the invention | |
| WPE 35 | Whey protein concentrate | Reference |
| | with 35% protein | |
| Skim milk powder | | Reference |
| Milk protein isolate | | Reference |

### Experimental

### Apparatus

(a) HPLC system—Agilent 1200 (Agilent, Dublin, Ireland) or equivalent.
(b) MS/MS system—Agilent 6495 Triple Quadrupole (QqQ) with Electrospray Ionisation (ESI) (Agilent, Dublin, Ireland) or equivalent.
(c) Mass Spectrometry Software—Masshunter (Agilent) or equivalent.
(d) Analytical column—Agilent Zorbax SB-C18 2.1×100 mm, 1.8 p.m (Agilent, Dublin, Ireland) or equivalent.
(e) Guard column—Agilent Zorbax SB-C18 2.1×5 mm, 1.8 p.m (Agilent, Dublin, Ireland) or equivalent.
(f) Vortex mixer—(VWR, Dublin, Ireland) or equivalent.
(g) Thermomixer comfort—(Eppendorf AG, Hamburg, Germany) or equivalent.
(h) pH meter—Seven Easy (MettlerToledo, Ohio, USA) or equivalent.
(i) Analytical balances—MS204S/01 (MettlerToledo, Ohio, USA) or equivalent.
(j) Pipettes—100 μL, 1000 pi (VWR, Dublin, Ireland) and Distriman multi-dispenser pipette (Gilson, Bedfordshire, UK) or equivalent.
(k) Microcentrifuge tubes—1.5 mL volume (VWR, Dublin, Ireland) or equivalent.
(l) Centrifuge tubes—15 mL volume (VWR, Dublin, Ireland) or equivalent.
(m) Mobile phase containers—1 L, glass (S.C.A.T Europe, Morfelden-Walldorf, Germany) or equivalent.
(n) Autosampler vials and caps—1.5 mL, glass, screw cap (HPLC/GC Certified kit 1.5 mL amber glass vial, 9 mm closure silicone/PTFE; Agilent, Dublin, Ireland) or equivalent.
(o) Beakers—Glass, various sizes (VWR, Dublin, Ireland) or equivalent.
(p) Volumetric flasks—Glass, various sizes (VWR, Dublin, Ireland) or equivalent.
(q) Ultrasonic bath—Bransonic CPX 3800H (Branson Ultrasonics, Connecticut, USA) or equivalent.

### Chemicals and Reagents

(a) Water—≥18 MΩ·cm (Elga pureLAB ultra) or equivalent.
(b) Acetonitrile—LC-MS grade (VWR, Dublin, Ireland) or equivalent.
(c) Formic acid—99% LC-MS grade (VWR, Dublin, Ireland) or equivalent.
(d) Ammonium bicarbonate (ABC)—Analytical grade (Fluka, Dublin, Ireland) or equivalent.
(e) Urea—Analytical grade (Sigma-Aldrich, Dublin, Ireland) or equivalent.
(f) lodoacetamide—Analytical grade (Sigma-Aldrich, Dublin, Ireland) or equivalent.
(g) DL-dithiothreitol—Analytical grade (Sigma-Aldrich, Dublin, Ireland) or equivalent.
(h) Trypsin—Sequencing grade modified (Sigma-Aldrich, Dublin, Ireland) or equivalent.
(i) Bovine osteopontin—Lacprodan OPN-10 76.32%; value provided by the supplier based on a nitrogen conversion factor of 7.17*0.95 (Arta Ingredients, Aarhus, Denmark), isolated from bovine milk by filtration and ion-exchange chromatography; or equivalent.
(j) Reference Standard—Peptide GDSVAYGLK (SEQ ID NO:1) (BioSciences, Dublin, Ireland) or equivalent.
(k) Reference Standard—Peptide YPDAVATWLKPDPSQK (SEQ ID NO:2) (BioSciences, Dublin, Ireland) or equivalent.
(l) Internal Standard—HEAVY Peptide GDSV(A)YGLK (SEQ ID NO:1) (BioSciences, Dublin, Ireland) or equivalent.
(m) Internal Standard—HEAVY Peptide YPD(A)V(A)TWLKPDPSQK (SEQ ID NO:2) (BioSciences, Dublin, Ireland) or equivalent.

### Test Materials

(a) Milk protein fraction used in the invention (milk protein fraction obtained by the process described herein)
(b) Skim milk powder (SMP, 35% protein ingredient)
(c) Whey protein concentrate (WPC, 35% protein ingredient)
(d) Demineralised whey (demin whey, 12% protein ingredient)

### Solutions

(a) Extraction buffer (Urea 1 M, ABC 50 mM)—Into a 500 mL beaker weigh 3.953 g±0.001 g ammonium bicarbonate (ABC) and 60.05 g±0.001 g Urea and solubilize with water. Transfer quantitatively into a 1000 mL volumetric flask and dilute to volume with water.
(b) Ammonium bicarbonate buffer (ABC) (50 mM)—Into a 100 mL beaker weigh 395.3 mg±0.5 mg ABC and solubilize with water. Transfer quantitatively into a 100 mL volumetric flask and dilute to volume with water.
(c) Dithiothereitol (DTT) 90 mM—Into a 2 mL microcentrifuge tube weigh 27.8 mg DTT. Dissolve with 2000 pi water.
(d) lodoacetamide (IAA) 200 mM—Into a 2 mL microcentrifuge tube weigh 74.0 mg IAA. Dissolve with 2000 pi water. Note: Keep solution in the dark to prevent degradation.
(e) Trypsin 0.095 μg/μL—Re-disperse 100 lig of lyophilised trypsin in its vial by mixing with 1050 pi of 50 mM ABC buffer.
(f) Formic acid 0.1% (v/v) in acetonitrile 10% (v/v)—Into a 100 mL bottle with cap, mix 90 mL water and 10 mL acetonitrile. Add 100 pi formic acid and mix.
(g) Formic acid 0.2% (v/v) in acetonitrile 20% (v/v) Into a 100 mL bottle with cap, mix 80 mL water and 20 mL acetonitrile. Add 200 pi formic acid and mix.
(h) Mobile phase A (0.1% (v/v) formic acid in water)—Pipette 1 mL of formic acid into a 1 L glass mobile phase container containing 1 L of water. Invert and sonicate for 3 minutes.
(i) Mobile phase B (0.1% (v/v) formic acid in acetonitrile)—Pipette 0.5 mL of formic acid into a 1 L glass mobile phase container containing 500 mL of acetonitrile. Invert and sonicate for 3 minutes.
(j) Standard tuning solution for mass spectrometer tuning (Agilent, Dublin, Ireland), or equivalent.

### Standards

(a) OPN stock solution—A 10 mg/mL stock solution of OPN is made from bovine OPN raw material (Lacprodan OPN-10, Arla Ingredients) based on the stated purity of the ingredient. For example, into a 100 mL beaker weigh 1.3103 g±0.001 g of OPN raw material (for OPN purity of 76.3%, w/w) and solubilize with water. Transfer quantitatively into a 100 mL volumetric flask and dilute to volume with water. Ω
(b) OPN calibration curve—The following calibration standards were prepared, expressed as mg OPN per g of test sample: 10 mg/100 g, 50 mg/100 g, 100 mg/100 g, 200 mg/100 g, 300 mg/100 g and 500 mg/100 g. Into a 15 mL centrifuge tube pipette 2 μL, 10 μL, 25 μL, 40 μL, 60 μL, 100 pi of the OPN stock (10 mg/mL) and make up to 10 mL with extraction buffer.
(c) Internal Standard Stock solution HEAVY peptide working solution, 1 pmol/μL—In a 2 mL microcentrifuge tube, dilute both heavy peptides—GDSV* (GDSV(A)YGLK) (SEQ ID NO:1) and YPDA* (YPD(A)V(A)TWLKPDPSQK) (SEQ ID NO:2)—in acetonitrile and formic acid to achieve 1 pmol/μL, based on their purchased concentrations. In this study peptides were purchased at 5 pmol/μL, so 185 pi of each peptide stock solution was added to 555 μL of formic acid 0.1% (v/v) in acetonitrile 10% (v/v).
(d) Internal Standard Working solution HEAVY peptide working solution, 0.1 pmol/pi—Into a 2 mL microcentrifuge tube, mix 100 μL of internal standard stock solution (1 pmol/μL), and add 900 μL formic acid 0.1% (v/v) in acetonitrile 10% (v/v).
(e) Sample preparation—Into 15 mL centrifuge tube weigh, for example, 0.2 g 0.005 g of infant formula (for raw materials 30-40% w/v protein is desired so the sample weight must be adjusted accordingly) and make up to 10 mL with ABC (50 mM) urea (1 M) extraction buffer.
(f) 25 mg OPN/100 g IF spiked samples—Into 15 mL centrifuge tube weigh 0.2 g±0.005 g of infant formula (for raw materials 30-40% w/v protein is desired so the sample weight must be adjusted accordingly), pipette 5 μL of OPN stock and make up to 10 mL with extraction buffer.
(g) 300 mg OPN/100 g IF spiked samples—Into 15 mL centrifuge tube weigh 0.2 g±0.005 g of infant formula (for raw materials 30-40% w/v protein is desired so the sample weight must be adjusted accordingly), pipette 60 pi of OPN stock and make up to 10 mL with extraction buffer.

### Sample Extraction and Preparation of LC-MS Analysis

The thermomixer was set to 60° C. and the calibration curve samples and test samples, prepared in 15 mL centrifuge tubes, were heated for 30 min with mixing at 600 rpm before being removed and allowed to cool to room temperature. An aliquot (500 μL) of each was transferred to a 1.5 mL microcentrifuge tube, mixed with 40 pi of DTT (90 mM), and placed in the thermomixer at 60° C. for 30 minutes. The tubes were then removed and allowed to cool to room temperature, mixed with 40 pi IAA (200 mM), and stored in the dark for 30 minutes to allow alkylation to occur. A 50 pi aliquot of solution was then transferred to a 1.5 mL microcentrifuge tube containing 150 pi of 50 mM ABC and 100 pi of trypsin (0.095 μg/μL) and incubated in the thermomixer for 2 h at 37° C. to allow protein digestion. Once completed, 50 μL of formic acid 0.2% (v/v) in acetonitrile (20%, v/v) was added to each tube and mixed. From this solution, 100 pi was transferred to a glass HPLC vial insert containing 100 pi of the internal standard working solution (0.1 pmol/μL). The vial was sealed, vortexed and then transferred to the HPLC for analysis.

### LC-MS/MS Parameters

The reversed-phase chromatographic separation was performed on an Agilent 1200 series ultra high-pressure liquid chromatography (UHPLC) system using an aqueous mobile phase of 0.1% formic acid in water (A) and an organic mobile phase of 0.1% formic acid in acetonitrile (B). The Agilent Zorbax SB-C18 (2.1×100 mm, 1.8 μm) HPLC column with Agilent Zorbax SB-C18 (2.1×5 mm, 1.8 μm) guard column were used, with a flow rate of 0.2 mL/min. The column was maintained at 40° C. by a column oven and the injection volume was 20 μL. The peptides were eluted with the following gradient: 0 min-10% B, 5 min-15% B, 10 min-20% B, 12 min-20% B, 20 min-30% B, 22 min-100% B, 23 min-100% B, 23 min-100% B, 23.01 min-10% B, 33 min-10% B. MS detection was performed using an Agilent 6495 QqQ system with the ESI source set to positive ionization mode. Tuning of the MS was performed using a standard tuning solution (Agilent, Dublin, Ireland). The MS parameters were optimized for each peptide. The optimized source parameters can be found in Table 2. OPN was quantified using two signature peptides: YPDAVATWLKPDPSQK (SEQ ID NO:2), 606.0 m/z [M+3H]³⁺ and GDSVAYGLK (SEQ ID NO:1), 455.2 m/z [M+2H]²⁺. Two transitions for each peptide were monitored—YPDA peptide (SEQ ID NO:3) (670.9 and 458.7 m/z) and GDSV peptide (SEQ ID NO:4) (551.1 and 313.1 m/z)—with YPDA transition 606.04670.9 used for protein 25 quantification. Corresponding internal standard peptides were also monitored—YPD(A)V(A)TWLKPDPSQK (SEQ ID NO:2), 608.8 m/z [M+3H]³⁺ and GDSV(A)YGLK (SEQ ID NO:1), 457.3 m/z [M+2H]²⁺—with YPD(A) transition 608.8→671.3 used for quantification by calculating the ratio of the chromatographic area of the YPDA quantitation ion (606.0→670.9 m/z) to that of the YPD(A) internal standard (608.84671.3). The ratio was plotted against the concentration of the corresponding calibration curve concentrations. The linear calibration curve fit obtained yielded a regression, R², of ≥0.995. For positive confirmation all ions must be detected, the associated chromatographic peak must exhibit a retention time of within ±2.5% of the average RT of the calibration standards, and the product ions ratios must be within 20% of the product ion ratios obtained from the calibration standards. The ratio of YPDA/GDSV was also monitored, with a peak area limit established of 31.5±20%.

TABLE 2
Optimised ESI source parameters to maximise
detection of peptides YPDAVATWLKPDPSQK (SEQ ID
NO: 2) and GDSVAYGLK (SEQ ID NO: 1) in positive-
ion mode.

| Parameter | Unit | Value |
|---|---|---|
| High-pressure RF | mV | 110 |
| Low-pressure RF | mV | 60 |
| Sheath gas temperature | ° C. | 250 |
| Sheath gas flow | L/min | 11 |
| Drying gas temperature | ° C. | 210 |
| Drying gas flow | L/min | 11 |
| Nebulizer pressure | psi | 20 |
| Capillary voltage | V | 3000 |
| Nozzle voltage | V | 500 |

### Results and Discussion

### Peptide Selection

Initial selection of peptides was guided by simulating tryptic digestion of bovine OPN using the ExPASy peptide cutter tool (https://web.expasy.org/peptide_cutter/). Potential candidate peptides were chosen based on their length (8-16 aa), absence of specific amino acids that tend to be reactive (Met, His, Cys) and specific motifs (no glycosylation site and no phosphorylation residues).

Experimental verification of the presence of the selected peptides identified two peptides for use in the method after digestion with trypsin: YPDAVATWLKPDPSQK (residues 20-35) (SEQ ID NO:2) and GDSVAYGLK (residues 137-145) (SEQ ID NO:1).

### Method Development

Chemically synthesised peptides YPDAVATWLKPDPSQK (SEQ ID NO:2) and GDSVAYGLK (SEQ ID NO:1) were used to optimise the LC-MS/MS method. Several columns, mobile phases and gradients were trialled. Analytical separation of the two peptides was achieved on an Agilent Zorbax SB C18 column by employing gradient chromatography using a mobile phase of water with 0.1% formic acid and acetonitrile with 0.1% formic acid. The following source parameters were optimised on the Agilent 6495 QqQ in the following order: high pressure RF, low pressure RF, sheath gas temperature, sheath gas flow, gas temperature, gas flow, nebuliser, capillary, and nozzle voltage to provide optimum response for both peptides. The most intense transition was used for quantification and the second most intense transition was used for confirmation. For these determined quantifier and qualifier transition ions selected for each peptide, optimum collision energies and peak area ratios were determined. Only peptide YPDAVATWLKPDPSQK (SEQ ID NO:2) was ultimately used for quantification of OPN in the samples because of its strong abundance when tested experimentally, with the other transitions serving as positive identifiers of the protein.

Several different extraction conditions were assessed and compared and the method providing the highest signal abundance was selected for validation. The trypsin used appeared to have the greatest influence on the quality of peptides produced and, therefore, on method performance. After the digestion method was established, the calibration curve linearity was assessed. Due to the variability sometimes observed from day to day, it is advised to digest raw material for the calibration curve within the same run as the samples being assessed to mitigate against this variability as much as possible. Once the calibration curve and the samples were extracted on the same day and the calibration curve produced met the minimum coefficient of determination (R2 0.995), then the trypsin employed was deemed acceptable.

Extraction of OPN was performed in urea/ammonium bicarbonate buffer at 60° C. in order to denature and open the protein structure to maximize access of trypsin to the cleavage sites. Reduction was achieved with DTT to break inter- and intramolecular disulfide linkages, and alkylation with IAA prevented any post-reduction thiol group reactions. Digestion was performed with trypsin, and digestion for longer than 2 h did not yield any extra signal during LC-MS/MS analysis. As touched upon above, the source of trypsin employed had the greatest influence on the peptides obtained, and the use of various sources of trypsin may need to be assessed further if the synthetic OPN peptides are employed as opposed to OPN protein digestion for establishing the calibration curve. Matrix matched calibration curves (milk based IF) were performed in the initial assessment of the method for method development but digestion of just the raw material was deemed acceptable to allow the determination of OPN in various different matrices.

### Method Validation

Osteopontin is considered positively identified in the sample when all the following confirmation criteria (as defined in EU commission Decision 2002/657/EC) for the two peptides used YPDAVATWLKPDPSQK (SEQ ID NO:2) and GDSVAYGLK (SEQ ID NO:1) are fulfilled: (i) signal is visible at the two diagnostic transition reactions selected for each peptide and at the two diagnostic transition reactions selected for its corresponding IS; (ii) the ratio of the chromatographic retention time of the analyte is within ±2.5% to the average relative retention time of the calibration curve; (iii) the peak ratio of the transition reactions for YPDA (SEQ ID NO:3) and GDSV (SEQ ID NO:4) are within 20% of the values determined during validation.

Calibration curves were achieved by the sample preparation described above with OPN raw material as a reference standard using the CoA value as there were no certified raw materials available for OPN at the time of method development.

Linearity of response was assessed by preparing standard solutions of 6 different OPN concentrations between 10 mg/100 g and 500 mg/100 g in triplicate. The concentration ratio (analyte/corresponding internal standard) was plotted against the area ratio (analyte/corresponding internal standard), and linearity was evaluated by least-squares regression analysis of peak area ratio versus concentration ratio, with an acceptable value of 0.999 obtained. Residual plots were assessed as a further test of linearity, with a deviation from the line of best fit of <0.01. LOD was not determined so LOQ was determined as the lowest point of the calibration curve (10 mg/100 g).

Accuracy and precision were determined by spiking OPN at a rate of 25 mg/100 g or 300 mg/100 g in each matrix in duplicate over 6 days, in the same laboratory, by the same operator and using the same equipment. The summarized validation outcomes are detailed in Tables 2-7. The repeatability was <10% and the intermediate reproducibility<15% in all cases. Greater than 90% recovery was obtained for both spike levels in each of the matrices, except for whey protein concentrate and demineralized whey; in these two matrices the mean recovery was 88.7% and 88.6%, respectively, at the 300 mg/100 g spike level, despite the method proving to be highly accurate when these matrices were spiked at 25 mg/100 g.

In all, a reliable and repeatable method was developed, allowing for the potential determination of OPN from a wide range of dairy products.

### Method Application

The method was assessed for skimmed milk powder (SMP, 35% protein ingredient), whey protein concentrate (WPC, 35% protein ingredient), alpha-lac enriched whey protein concentrate (a-lac WPC, 80% protein ingredient), demineralised whey ingredients (demin whey, 12% protein) and for the milk protein fraction used in the present invention.

Thirteen batches of each raw material were assessed and an average OPN content was determined for each. These typical values were then used to complete OPN mass balances using formulations of known composition, as a means of indirectly assessing method recovery. The a-lac WPC contained the highest OPN concentration (Table 8), which explains why IF (made with this material) had a higher mean content than GUM (made with WPC 35%). SMP contained the lowest OPN concentration, and each material showed a reasonable degree of natural variability (relatively high % RSD), which is not surprising. Considering this innate variability, the analysed OPN contents of IF and GUM were similar to the expected values derived by mass balance.

Recent trends in infant formula development are focused on the addition of nutrients, but the development and application of specialised protein isolates can be expensive. Therefore, assessment of raw materials and selection of those with naturally enhanced OPN through the production process would lead to increased levels of OPN being present in IF and GUM without the need to fortify with an additional ingredient. The method described shows that this OPN method is fit for purpose and can be applied to the measurement of OPN either as a pure ingredient or in infant formula or growing up milk.

### Conclusions

OPN is naturally present at relatively low concentrations in many dairy ingredients, and products comprised of these materials. Infant formula and GUMS are complex protein systems, and it has traditionally been difficult to quickly and routinely detect and quantify low-abundance proteins in such systems. This method, based on signature peptides, allows the user to rapidly detect and quantify OPN with minimal sample extraction and pre-treatment, with high selectivity and accuracy.

The results of the LC-MS/MS analysis are provided in Table 3 below.

TABLE 3
Amount of osteopontin present in the
test samples and in the references

| | Osteopontin level, | Typical protein |
|---|---|---|
| Sample | mg/100 g of ingredient | content |
| Milk protein fraction used | 245 | 45.0% |
| in the present invention | | |
| WPE 35 | 171 | 36.5% |
| Skim milk powder | 57.2 | 36.5% |
| Milk protein isolate | 63.2 | 90.0% |

The milk protein fraction obtain as described herein thus had by far the highest amount of osteopontin compared to other samples, which makes it particularly suitable as a source of osteopontin.

### Conclusion

The osteopontin levels found in commercially available dairy ingredients used for the manufacture of infant formula can vary, depending on their composition and the manufacturing processes used. This, in turn, affects the osteopontin content of subsequent formulations that use these ingredients. The possibility to enrich ingredients in useful nutrients, such as osteopontin, while enriching other key components, is an area with significant potential for further development. Enriching existing ingredients in osteopontin with a milk protein fraction may negate the necessity to add additional exogenous sources, while still providing infant nutritional products with osteopontin levels similar to those in human milk. Use of alternative milk protein fractions can provide the desired protein profile but may lack additional benefits such as increased osteopontin levels.

### Example 2

Examples of synthetic nutritional compositions (infant formulas) in accordance with the invention is set out in Tables 4 to 7.

TABLE 4
composition of Infant Formula A

| | UNITS | Amount in Infant |
|---|---|---|
| NUTRIENT | per 1013 g | Formula A |
| Energy | kcal | 507.25 |
| Energy | kJ | 2121.82 |
| Water | G | 2.50 |
| Ash | G | 3.64 |
| Protein | g | 10.15 |
| Whey | g | 6.60 |
| Casein | g | 3.55 |
| Osteopontin | mg | 85.00¹⁾ |
| Carbohydrates | g | 58.44 |
| Available Carbohydrates | g | 54.17 |
| of which lactose | g | 54.17 |
| of which sugars | g | 54.17 |
| Fiber | g | 2.27 |
| Fructo-oligosaccharides | g | 2.27 |
| Total Fat | g | 27.27 |
| Linoleic Acid | mg | 3939.40 |
| Linolenic Acid | mg | 318.20 |
| linoleic:alpha-linolenic acid ratio | ratio | 12.38 |
| ARA | mg | 95.50 |
| DHA | mg | 95.50 |
| ARA/DHA | ratio | 1.00 |
| 1-3-Dioleoyl-2-palmitoyl | g | 4.00 |
| triglyceride | | |
| Vitamins | | |
| Vitamin A (Retinol) | mcg RE | 549.10 |
| Beta-carotene | mcg | 113.60 |
| Vitamin D (Cholecalciferol) | mcg D | 7.27 |
| Vitamin E (TE) | mg | 6.61 |
| Vitamin K | mcg | 40.64 |
| Vitamin B1 (Thiamine) | mg | 0.95 |
| Vitamin B2 (Riboflavin) | mg | 0.70 |
| Vitamin B6 (Pyridoxine) | mg | 0.57 |
| Vitamin B12 (Cyanocobalamin) | mcg | 1.74 |
| Niacin | mg | 4.74 |
| Folic Acid | mcg | 75.80 |
| Pantothenic Acid | mg | 2.84 |
| Biotin | mcg | 18.90 |
| Vitamin C (Ascorbic acid) | mg | 68.20 |
| Minerals and Trace Elements | | |
| Calcium | mg | 324.20 |
| Phosphorus | mg | 181.80 |
| Ca:P | ratio | 1.78 |
| Magnesium | mg | 36.40 |
| Iron | mg | 6.06 |
| Zinc | mg | 4.55 |
| Manganese | mcg | 50.00 |
| Copper | mg | 0.39 |
| Iodine | mcg | 90 |
| Sodium | mg | 115.00 |
| Potassium | mg | 470.00 |
| Chloride | mg | 328.00 |
| Selenium | mcg | 14.20 |
| Zn/Cu | Ratio | 11.82 |
| Manganese | mcg | 37.90 |
| Other substances | | |
| Choline | mg | 124.20 |
| Inositol | mg | 34.10 |
| L-Carnitine | mg | 7.58 |
| Lutein | mcg | 88.00 |

¹⁾45 mg of osteopontin are provided by 18.36 g of the milk protein fraction used in the invention.

The composition may be for use in an infant of 0 to 6 months.

TABLE 5
composition of Infant Formula B

| | UNITS | Amount in Infant |
|---|---|---|
| NUTRIENT | per 100 g | Formula A |
| Energy | kcal | 478.06 |
| Energy | kJ | 2005.16 |
| Water | G | 2.50 |
| Ash | G | 3.52 |
| Protein | g | 15.25 |
| Whey | g | 6.10 |
| Casein | g | 9.15 |
| Osteopontin | mg | 85.001) |
| Carbohydrates | g | 57.45 |
| Available Carbohydrates | g | 55.32 |
| of which lactose | g | 55.32 |
| of which sugars | g | 55.32 |
| Fiber | g | 2.13 |
| Fructo-oligosaccharides | g | 2.13 |
| Total Fat | g | 21.28 |
| Linoleic Acid | mg | 3000.00 |
| Linolenic Acid | mg | 296.20 |
| linoleic:alpha-linolenic acid ratio | ratio | 10.13 |
| ARA | mg | 80.90 |
| DHA | mg | 80.90 |
| ARA/DHA | ratio | 1.00 |
| 1-3-Dioleoyl-2-palmitoyl | | |
| triglyceride | g | 4.00 |
| Vitamins | | |
| Vitamin A (Retinol) | mcg RE | 418.34 |
| Beta-carotene | mcg | 106.40 |
| Vitamin D (Cholecalciferol) | mcg D | 7.94 |
| Vitamin E (TE) | mg | 4.76 |
| Vitamin K | mcg | 31.20 |
| Vitamin B1 (Thiamine) | mg | 0.45 |
| Vitamin B2 (Riboflavin) | mg | 1.00 |
| Vitamin B6 (Pyridoxine) | mg | 0.36 |
| Vitamin B12 (Cyanocobalamin) | mcg | 1.28 |
| Niacin | mg | 3.78 |
| Folic Acid | mcg | 95.00 |
| Pantothenic Acid | mg | 2.48 |
| Biotin | mcg | 10.60 |
| Vitamin C (Ascorbic acid) | mg | 63.80 |
| Minerals and Trace Elements | | |
| Calcium | mg | 538.30 |
| Phosphorus | mg | 361.70 |
| Ca:P | ratio | 1.49 |
| Magnesium | mg | 60.30 |
| Iron | mg | 8.51 |
| Zinc | mg | 4.26 |
| Manganese | mcg | 247.50 |
| Copper | mg | 0.21 |
| Iodine | mcg | 70.90 |
| Sodium | mg | 237.60 |
| Potassium | mg | 637.60 |
| Chloride | mg | 513.80 |
| Selenium | mcg | 13.50 |
| Zn/Cu | Ratio | 20.48 |
| Other substances | | |
| Choline | mg | 144.00 |
| Lutein | mcg | 0.16 |

1)45 mg of osteopontin are provided by 18.36 g of the milk protein fraction used in the invention.

The composition may be for use in an infant of 6 to 12 months

TABLE 6
composition of Infant Formula C

| | UNITS | Amount in Infant |
|---|---|---|
| NUTRIENT | per 100 g | Formula A |
| Energy | kcal | 440.83 |
| Energy | kJ | 1855.02 |
| Water | G | 3.00 |
| Ash | G | 4.00 |
| Protein | g | 13.91 |
| Whey | g | 5.67 |
| Casein | g | 8.34 |
| Osteopontin | mg | 85.001) |
| Carbohydrates | g | 63.91 |
| Available Carbohydrates | g | 62.13 |
| of which sugars | g | 46.87 |
| Fiber | g | 1.78 |
| Fructo-oligosaccharides | g | 1.78 |
| Total Fat | g | 14.80 |
| Linoleic Acid | mg | 2900.00 |
| Linolenic Acid | mg | 275.00 |
| linoleic:alpha-linolenic acid ratio | ratio | 10.55 |
| ARA | mg | 15.39 |
| DHA | mg | 50.00 |
| 1-3-Dioleoyl-2-palmitoyl | | |
| triglyceride | g | 3.00 |
| Vitamins | | |
| Vitamin A (Retinol) | mcg RE | 396.11 |
| Beta-carotene | mcg | 84.27 |
| Vitamin D (Cholecalciferol) | mcg D | 7.64 |
| Vitamin E (TE) | mg | 3.80 |
| Vitamin K | mcg | 41.04 |
| Vitamin B1 (Thiamine) | mg | 0.43 |
| Vitamin B2 (Riboflavin) | mg | 0.65 |
| Vitamin B6 (Pyridoxine) | mg | 0.35 |
| Vitamin B12 (Cyanocobalamin) | mcg | 1.39 |
| Niacin | mg | 3.37 |
| Folic Acid | mcg | 105.62 |
| Pantothenic Acid | mg | 2.83 |
| Biotin | mcg | 11.24 |
| Vitamin C (Ascorbic acid) | mg | 67.42 |
| Minerals and Trace Elements | | |
| Calcium | mg | 511.24 |
| Phosphorus | mg | 342.70 |
| Ca:P | ratio | 1.49 |
| Magnesium | mg | 44.94 |
| Iron | mg | 6.74 |
| Zinc | mg | 3.97 |
| Manganese | mcg | 50.00 |
| Copper | mg | 0.39 |
| Iodine | mcg | 90 |
| Sodium | mg | 115.00 |
| Potassium | mg | 470.00 |
| Chloride | mg | 328.00 |
| Selenium | mcg | 14.20 |
| Copper | Mg | 0.20 |
| Zn/Cu | Ratio | 20.15 |
| Manganese | mcg | 224.16 |
| Iodine | mcg | 75.00 |
| Sodium | mg | 220.00 |
| Potassium | mg | 800.00 |
| Chloride | mg | 380.00 |
| Selenium | mcg | 12.50 |
| Other substances | | |
| Lutein | mcg | 160 |

1)45 mg of osteopontin are provided by 18.36 g of the milk protein fraction used in the invention.

The composition may be for use in a child of 1 to 3 years

TABLE 7
composition of Infant Formula D

| | UNITS | Amount in Infant |
|---|---|---|
| NUTRIENT | per 100 g | Formula A |
| Energy | kcal | 442.22 |
| Energy | kJ | 1859.34 |
| Water | G | 3.00 |
| Ash | G | 4.98 |
| Protein | g | 17.03 |
| Whey | g | 6.81 |
| Casein | g | 10.22 |
| Osteopontin | mg | 85.001) |
| Carbohydrates | g | 59.00 |
| Available Carbohydrates | g | 55.94 |
| Fiber | g | 3.02 |
| Fructo-oligosaccharides | g | 3.02 |
| Total Fat | g | 16.04 |
| ARA | mg | 11.71 |
| DHA | mg | 43.69 |
| ARA/DHA | Ratio | 0.27 |
| 1-3-Dioleoyl-2-palmitoyl | | |
| triglyceride | g | 3.00 |
| Vitamins | | |
| Total Vitamin (RE) | mcg RE | 225.02 |
| Vitamin A (Retinol) | mcg RE | 215.56 |
| Beta-carotene | mcg | 56.76 |
| Vitamin D (Cholecalciferol) | mcg D | 3.96 |
| Vitamin E (TE) | mg | 33.78 |
| Vitamin K | mcg | 41.04 |
| Vitamin B1 (Thiamine) | mg | 0.35 |
| Vitamin B2 (Riboflavin) | mg | 0.45 |
| Vitamin B6 (Pyridoxine) | mg | 0.29 |
| Vitamin B12 (Cyanocobalamin) | mcg | 1.31 |
| Niacin | mg | 3.06 |
| Folic Acid | mcg | 39.64 |
| Pantothenic Acid | mg | 1.13 |
| Biotin | mcg | 9.01 |
| Vitamin C (Ascorbic acid) | mg | 21.62 |
| Minerals and Trace Elements | | |
| Calcium | mg | 465.00 |
| Phosphorus | mg | 380.63 |
| Ca:P | ratio | 1.22 |
| Magnesium | mg | 53.15 |
| Iron | mg | 4.60 |
| Zinc | mg | 0.45 |
| Manganese | mcg | 714.4 |
| Copper | mg | 0.37 |
| Zn/Cu | Ratio | 1.20 |
| Iodine | mcg | 45.05 |
| Sodium | mg | 234.23 |
| Potassium | mg | 900.90 |
| Chloride | mg | 450.45 |
| Selenium | mcg | 11.26 |
| Other substances | | |
| Choline | mg | 135.14 |
| Lutein | mcg | 130 |

1)45 mg of osteopontin are provided by 18.36 g of the milk protein fraction used in the invention.

The composition may be for use in a child of 3 to 8 years

### Example 3

### Experimental

### Material

The combined eluate and the washings after the regeneration of the anionic resin exchanger, namely the cGMP fraction, is used as the raw material for ultrafiltration trials.

### Processing

The trials were performed on the bench scale Maxi Mem Membrane Filtration unit by PS Prozesstechnik GmbH in the Science and Technology Diary laboratory. The following range of membrane sizes were used:

| membrane | cut-off size | |
|---|---|---|
| 1 | 5 | kDa |
| 2 | 10 | kDa |
| 3 | 30 | kDa |
| 4 | 50 | kDa |
| 5 | 100 | kDa |

| | |
|---|---|
| 6 | 0.2 mm (MF) |

The filtration trials were run at 14° C. and a starting pressure of 3 bar. The starting pH ranged between 6.9 and 7.1. As expected, the flux at the beginning of the trials increases with an increase in the selected membrane size. Furthermore, the flux within the trials decreases over time. This is as expected due to the formation of a fouling layer on the membrane or the increase of the dry matter retentate, with an increasing average of molecule size in the retentate over time.

Permeate and retentate samples were collected throughout the filtration process or only at the end of the filtration process. The samples were analyzed for their dry matter, protein, ash and OPN contents.

### Dry Matter, Protein and Ash Results

The following results were found on the dry matter and the protein contents:

Both the dry matter and protein levels show the expected increase of the permeate fraction with an increasing membrane size.

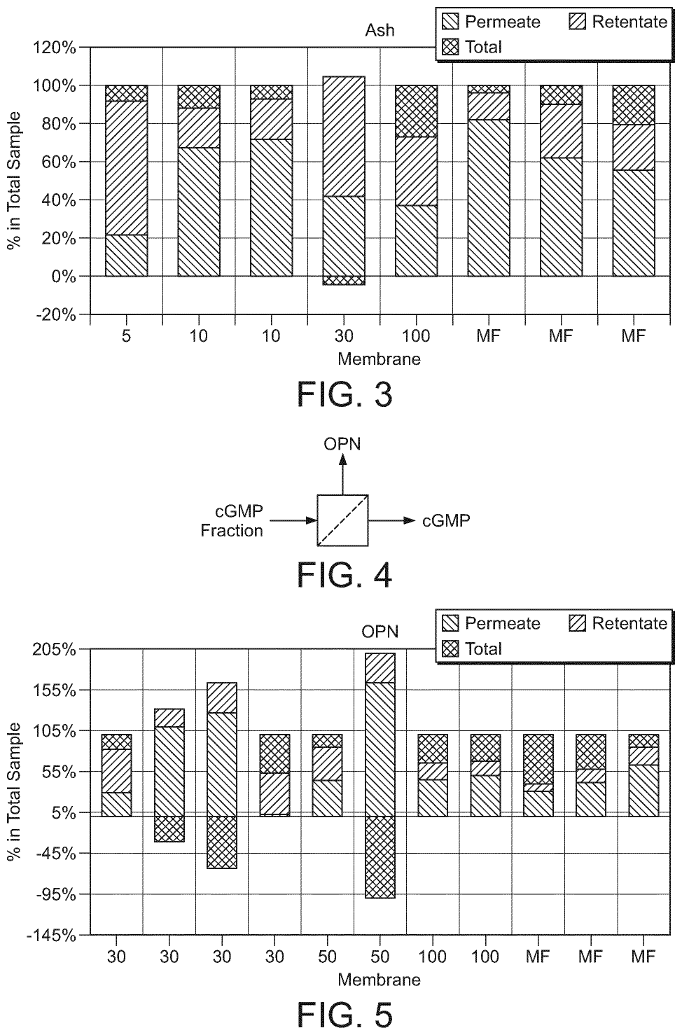

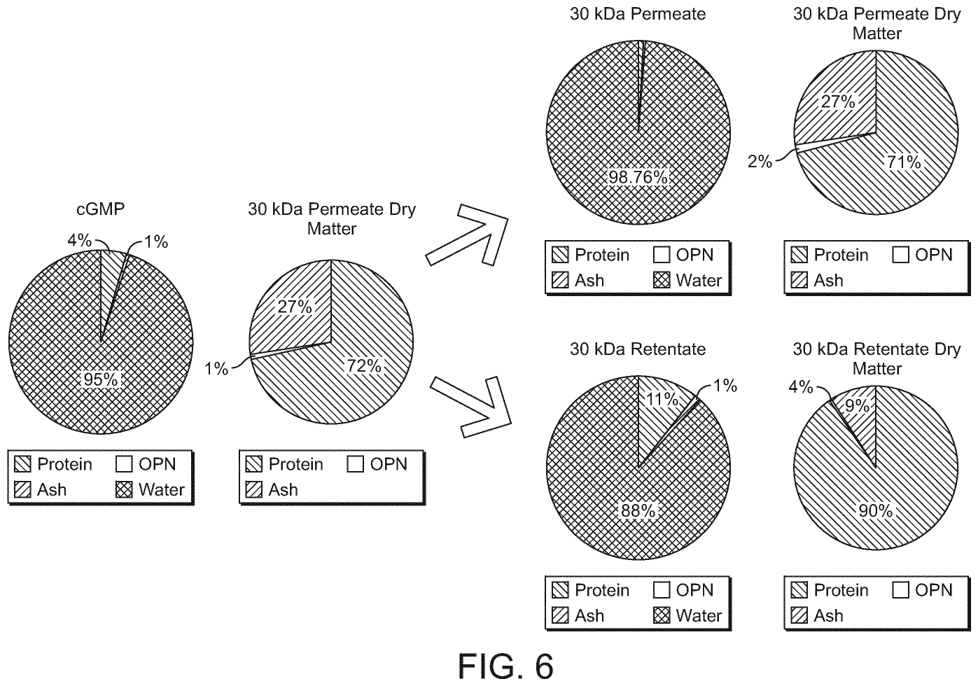

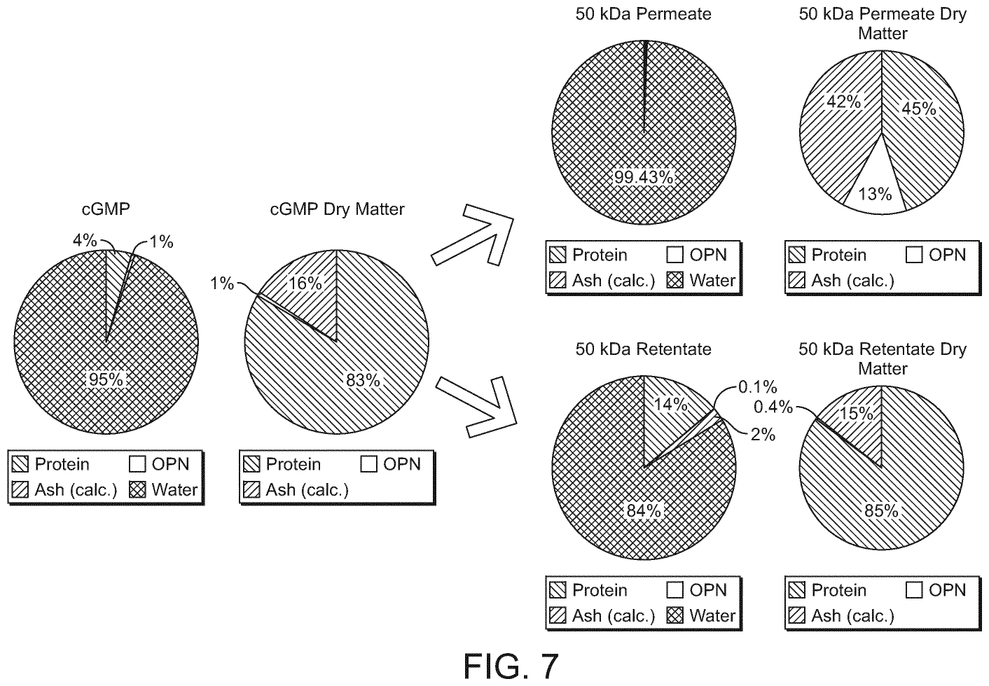

As all minerals should pass through the selected membranes, the levels of ash are expected to be higher throughout the permeate proportion (see FIG. 3) Higher ash levels in the retentate at 5 and 30 kDa, in comparison to the 10 kDa membrane could result from the high levels of protein in the retentate that possibly bind the minerals. All other membrane sizes show the expected high ash level in the permeate.

### OPN Results

With OPN sizes ranging between 34-70 kDa and a cGMP molecular weight of 8 kDa, initial trials were based on 30-50 kDa membrane cut off sizes. Theoretically, the filtration should lead to OPN remaining in the retentate and cGMP and other molecules going into the permeate (FIG. 4).

However, the results show that most of the OPN fraction ends up in the permeate. Even though OPN is theoretically a bigger molecule than the theoretical cut off size, it still passes through the membrane rather than being retained as expected.

Furthermore, as the protein fraction of the starting material which mainly consists of cGMP, stays in the retentate fraction, it means that this fraction is agglomerating to a greater molecular size than its monomeric weight of 8 kDa.

The most promising membrane results can be found with a 30 kDa membrane, where the fourth sample shows the highest fraction of OPN retention. In the actual dry matter fraction (FIG. 9), OPN does not show a significant increase, however OPN was enriched by 64% in the retentate in comparison to the cGMP fraction. The greatest enrichment was achieved with the 50 kDa membrane. Here the permeate was enriched by 107% and the retentate by 73%. The contradiction to enrichment in both fractions is visible in FIG. 5. It shows that sample 6 exceeds 100% of the original sample.

### CONCLUSION

As expected, all processing parameters show a decrease in flux throughout the filtration processes. The success of the filtration trials can also be demonstrated with the analyzed dry matter, protein and ash fractions that increase in the permeate, with an increasing membrane size. However, the OPN fraction mainly remains in the permeate against expectation. The greatest enrichment was achieved with the 50 kDa membrane, where the permeate is enriched by 107% and the retentate by 73%. As these results contradict the theory of enrichment, the most promising results are found with a 30 kDa membrane. Here OPN is enriched by 64% in the retentate in comparison to the cGMP fraction.

1. A method for producing a milk protein fraction as a source of osteopontin (OPN) in a synthetic nutritional composition for an infant or child comprising:
i) providing a liquid lactic raw material
ii) decationization of the liquid lactic raw material, such that the pH has a value of 1 to 4.5,
iii) bringing the said liquid into contact with a weak anionic resin of hydrophobic matrix, predominantly in alkaline form up to a stabilized pH,
iv) separation of the resin and the liquid product which is recovered,
v) desorption of CGMP from the resin,
vi) performing at least one ultrafiltration step, and
vii) collecting the permeate and/or retentate fraction rich in OPN.

2. Method of claim 1, wherein the steps v-vi is performed under pH ranging from 4 to 8.

3. Method of claim 2, wherein the ion balance is further modified by calcium or phosphate addition.

4. Method of claim 1, wherein the ultrafiltration step is performed using membrane size between preferably 30 to 100 KDa.

5. Method of claim 1, wherein said milk protein is added to said composition in an effective amount sufficient to ensure that said synthetic nutritional composition has a final concentration of osteopontin in a range found in human breast milk.

6. A method for providing nutrition to an infant or child comprising administering a synthetic nutritional composition to the infant or child comprising a milk protein produced by a milk protein fraction as a source of osteopontin (OPN) in a synthetic nutritional composition for an infant or child comprising:
i) providing a liquid lactic raw material
ii) decationization of the liquid lactic raw material, such that the pH has a value of 1 to 4.5,
iii) bringing the said liquid into contact with a weak anionic resin of hydrophobic matrix, predominantly in alkaline form up to a stabilized pH,
iv) separation of the resin and the liquid product which is recovered,
v) desorption of CGMP from the resin,
vi) performing at least one ultrafiltration step, and
vii) collecting the permeate and/or retentate fraction rich in OPN wherein the synthetic nutritional composition comprises the milk protein fraction in a concentration in a range of 4 to 30 g/L.

7. Method according to claim 6 wherein said composition is an infant formula comprising 16 to 30 g/L of the milk protein fraction and wherein said composition is preferably formulated for an infant of 0 to 6 months of age.

8. Method according to claim 6 wherein said composition is an infant formula comprising 8 to 30 g/L of the milk protein fraction and wherein said composition is formulated for an infant of 6 to 12 months of age.

9. Method according to claim 6 wherein said composition is an infant formula comprising 10 to 30 g/L of the milk protein fraction and wherein said composition is formulated for a child of 12 to 36 months of age.

10. Method according to claim 6 wherein said composition is an infant formula comprising 12 to 30 g/L of the milk protein fraction and wherein said composition is formulated for a child of 3 to 8 years of age.

11. Method according to claim 6, wherein the osteopontin concentration in said composition is at least 10 mg/L.

12. Method according to claim 6, wherein the synthetic nutritional composition for an infant or child is a composition for consumption by infants either alone or in combination with human breast milk and is an infant formula or human breast milk fortifier.

13. Method according to claim 6 for use in a method to promote and/or optimise the growth and/or the development in an infant or child to whom it is administered.

14. Method according to claim 6 for use in a method to promote and/or optimise immune defenses in an infant or child to whom it is administered.

15. Method according to claim 6 for use in a method to promote and/or optimise galactose metabolism in an infant or child to whom it is administered.

16. Method according to claim 6 for use in a method to promote and/or optimise cytoskeleton remodeling.
